(19) United States
(12) Patent Application Publication
(10) Pub. No.: US 2004/0213336 A1
(43) Pub. Date: Oct. 28, 2004

(54) Micro-modem

(76) Inventor: Daljit S. Jandu, N. Hollywood, CA (US)

Correspondence Address: Daljit S. Jandu, Apt. 9, 6600 Whitsett Avenue, N. Hollywood, CA, 91606, US

(21) Appl. No.: 10/270,433

(22) Filed: Oct. 15, 2002

(51) Int. Cl. H04B 1/38; H04L 5/16

(52) U.S. Cl. 375/222

(57) ABSTRACT

The patent application for this special modem has it's root in Reimann Hypothesis, Prime Number Theorem, The Birch and Swinnerton-Dyer Conjecture, Hodge Conjecture, Ramanujan Conjecture as well as P-NP problem. These are well known conjectures/problems in the mathematics and there is 1 million prize on each by Clay Mathematics Institute (www.claymath.org). The insights are possible only when solving these or related conjectures The wave generation in any amplifier input/output and it's optimization is the result of pull-push characteristics which felicitates the non-Euclidian approach of solving the data communication and networking problems. The electronic components e.g. XOR gates etc. are used for digitization of the wave, if required.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to micro-modem, specifically to use OSI (Open System Interconnection) Reference Model Layers to transmit high speed data, voice, audio, video and frame relay traffic in real time.

### BACKGROUND OF THE INVENTION

The conventional modems (acronym for MOdulator/DEModulator) comprise equipment which converts digital signals to analog signals and vice versa. Modems are used to send data over PSTN (Public Switched Telephone Network. Although the carrier switches (i.e. central offices and tandem offices) are typically digital, as is the backbone transmission network (e.g. T-carrier), the local loop always is analog unless the user orders a more costly digital loop (e.g. ISDN or T1). Therefore the PSTN is analog as far as most people concerned.

Conventional modems work like this. The PC outputs data in the form of “1's” and “0's” which are represented by varying levels of voltage. The modem converts the digital data signal into variation of analog sine wave so the data can be transmitted over the PSTN. A matching modem on the other end reverses the process in order to present the target device with a digital bit stream. The modulation techniques include some combination of Amplitude Modulation (AM), Frequency Modulation (FM) and Phase Modulation (PM) also known as Phase Shift Keying (PSK). Used in this combination, these techniques allow multiple bits to be represented with a single (or single set) of sign waves. In this fashion, compression is accomplished, which allows more data to be transferred in same period of time and which therefore reduces the connect time and the associated cost of data transfer. Contemporary, conventional modem are standardized by ITU-T as a part of “V” series of standards. Such modems are characterized by error detection and correction mechanisms, adaptive equalization, internal dialing, and numerous other sophisticated capabilities. 56 Kbps are the latest development in the world of conventional modems.

Modem Standards:

Definitions of electrical and telecommunications characteristics which enable modems of dissimilar manufacturers to speak to each other.

Bell 103 . . . U.S. standard for 300 bps; ITU-T V.21 . . . International standard for 300 bps; Bell 212A . . . U.S. standard for 1200 bps; ITU-T V.22 . . . International standard for 1200 bps, ITU-TV.22 bis . . . U.S. and international standard for 2400 bps; ITU V.23 . . . International video-tex standard (1200/75 bps or 75/1200 bps)

Hayes AT Command Set for Smart Modem (such as automatic dialing) and V series recommendation i.e. V.34.

V.34 is the international standard for dial up modems up to 28,800 bits per second. V.34 have standard features to adjust to the noise of telephone line. V.34 are the first modems to identify themselves to telephone network (handshaking). V.34 bis increases the speed up to 31,200 bits per second and 33,600 bits per second. V.34 bis is now the most common standard for PC data communications over dial-up phone lines.

V.42bis an ITU-T standard compresses data at an average ratio 3.5:1 and can yield file transfer up to 9600 bps on 2400 bps modem, 38,400 bits per second with a 9600 bps modem, 57,600 bps with a 14,400 modem, or 115,600 bits per second on a 28,800 bps modem.

V.42 Error Correction ITU-T error-correction standard specifying both MNP4 and LAP-M. The ITU-T title says “Error-correcting procedures for DCE using asynchronous-to synchronous Conversion”

V.44 makes use of LZJH (Lempel-Ziv-Jeff.Heath) compression algorithm and provides 6:1 compression ratio. When compared to V.42bis running in V.90 modems, V.44 running in V.92 modems can yield speed improvements of 20% to 60%, up to as much as 200% for certain types of highly compressible data.

V.54 ITU-T standard for loop test devices in modems, DCE (Data Communication Equipment) and DTE (Data Terminal Equipment). V.61 ITU-T is a 14.4 kbps V.32bis analog multiplexing technology standard developed by AT& T Paradyne and marketed as VoiceSpan. The data rate is reduced to 4800 bps during simultaneous voice and data. This analog Simultaneous voice and data (ASVD) standard has now been obsoleted by V.70

V.70 which replaces V.61 is the ITU-T standard for Digital Simultaneous Voice and Data (DSVD) modems. DSVD allows the simultaneous transmission of data and digitally encoded voice signal over a single dial-up analog phone line. DSVD modems use for V.34 modulation (up to 33.6 kilobits per second), but may also use V.32bis modulation (14.4 kilobits per second)

V.75 ITU-T recommendation which specify DSVD control procedures.

V.76 ITU-T recommendations which defines V.70 multiplexing procedures.

V.8 A way V.34 modems negotiate connection feature and options.

V.8bis New start-up sequence for multimedia modems.

V.80 V.80 is the interface defined in H.324 ITU video conferencing standard. A V.80 modem provides a standard method for H.324 applications to communicate over modems. A V.80 provides three main function:

1. Converts synchronous H.324 streams to run on asynchronous modem connections. That is, they accept and send data in synch device with a timing device (“clock”). Serial ports and modems are asynchronous, meaning they accept and receive data independent of any clocking device. V.80 coverts the synchronous data stream of H.324 application so that it can communicate through the asynchronous modem.

2. Depending upon line conditions, a V.80 modem alerts on H.324 video of its rate of adjustments thereby allowing the application to adjust the rate at which it sends video and audio.

3. Communicates lost packets to the H.324 application. During transmission, data can be lost due to buffer overflows, phone line errors and other issues. Under these conditions, a V.80 modem communicates lost data information to the H.324 application, helping it to keep real.

V.90: An ITU-T standard for Pulse Code Modulation (PCM) modems running at the speeds to 56 Kbps. V.90 was assigned when the formal standard was approved on Feb. 6, 1998. V.90 supports transmission on asymmetric basis. Currently, the maximum downstream rate is 53.5 Kbps, as the standard exceeds maximum amplitude level supported over local copper loops. this restriction is expected to ease into the future, thereby allowing V.90 signaling rate the full potential of 56Kbps.

V.91: is a developing standard from the ITU-T, V.91 is all digital extension to V.90. V.91 will allow modem signals to be transmitted over digital circuits, such as ISDN BRI (Basic Rate Interface) local loops in consumer and home office applications and PRI (Primary Rates Interface) local loops that connect to corporate PBXs. Thereby, end users can achieve connectivity to ISPs and other supporting V.90 modem access. In absence of V.91, such users can connect to an ISP, for example, only if the ISP also supports ISDN. V.91 is intended to operate at signaling rates up to 64 Kbps, and will make use of both 4-wire circuit-switched connections and leased point-to-point 4-wire digital connections.

V.92: A dial-up modem standard finalized by ITU-T in late 2000, as a successor to V.90. V.92 improves on V.90 in many ways. First, while V.92 runes at the same maximum 56-Kbps downstream signaling rate as V.90, it runs at a maximum of 48 Kbps upstream compared with V.90 speed of 33.6 Kbps. This improvement in the upstream signaling speed is due use of modulation standard known PCM upstream, with PCM meaning Pulse Code Modulation. PCM upstream improves the speed of upstream channel by making use of same clocking source for synchronization purposes as does the downstream channel. Second, V.92 makes use of V.44 compression standard, finalized by ITU-T in November, 2000. V.44 offers considerable improvement over V.42bis standard used in V.90 modems. Specifically V.44 offers compression ratio of 6:1 (6 to 1), while V.42bis was limited to 3.5:1. Depending on compressibility of subject data, V.44 therefore improves the throughput up to 200% or more over V.42bis. As a result, V.92 modems offer downstream throughput performance of as much as 300Kbps, compared with the 150-200 Kbps supported by V.90 modems. Third, the V.92 standard includes a feature known as QuickConnect, which reduces the time consumed in the handshaking process between two modems. QuickConnect can shave 10 to 20 seconds off the 20 to 30 seconds required to establish a dial up connection required by V.90 modems. Fourth, V.92 can both recognize and respond to the call waiting tone, and place the data call “on hold” while the voice call is answered. This feature can eliminate the need for second modem/fax line. As the server pauses the data session, it is easily and quickly resumed without the need for another dial-up session. Lastly, there is hope V.90 modems will be upgradable to V.92 modems through a software download.

The main issue surrounding pulse code modulation is the level of resolution,; i.e. say the reference voltage of 5 volts at the frequency of 4 Khz for 56Kbps modem would be high resolution in the ADC (Analog to Digital Converters) or DAC (Digital to Analog Converter). Moreover, the datas are not carried concurrently for voice, data, image, audio/video over the analog line. Even if the datas are to be simultaneously transferred, it may be ATM (Asynchronous Transmission Mode) which is yet to be put practice for PSTN. ATM is a network technology capable of transmitting data, voice, audio, video and frame relay traffic in real time. Data, including frame relay, is broken into packets containing of 53 bytes each, which are switched between any two nodes in the system at the rates ranging from 1.5 Mbps to 622 Mbps (over the fiber optic cable). The basic unit of ATM is known as a cell, a packet consisting of 5 bytes of routing information and a 48 byte payload (data). ATM is defined in the broadband ISDN protocol at the level corresponding to the levels 1 and 2 of ISO/OSI reference model. It is currently used in LANs (local area networks) involving workstations and personal computers.

### BACKGROUND OF THE INVENTION—OBJECTS AND ADVANTAGE

As we have noticed that in order for the simultaneous flow of data, image, audio/video, frame relay in analog fashion over the LAN/WAN/PSTN/Ethernet is limited by:

(1) Errors caused by synchronous to asynchronous conversions and vice versa (V.42)

(2) The standards for interfacing between DTE (Data Terminal Equipment, i.e. computer, server) and DCE (Data Communication Equipment, i.e. modem), the standard of which is set by EIA/TIA in United States.

(3) Analog Mixing of varied signals such as audio/video/image/data and even frame relay.

(4) Once the signals are mixed in analog fashion and transmitted over the network, how to design the oscillator or the clocking mechanism at the receiving end.

(5) ADC and DAC limitations on bits per seconds caused by PCM (Pulse Code Modulation) due to resolutions requirement.

(6) The career wave for phone lines is 3-6 KHz, career frequency of LAN/WAN such as ethernet, cable modem is considered upon which all the information is encoded and separated

(7) The method of separating the compound analog wave into components of audio/video/data/image/frame-relay etc. and method of XORing the same.

By keeping the above points in mind, the frequency divider or multiplier for the different types of datas, viz. the image data requires 300 times more frequency speed of throughput from DTE (data terminal equipment) to DCE (Data Communication Equipment) as compared to voice data. However, for mixing purpose, these speeds are to regulated in a specific order; i.e. if the 5 datas are to be mixed, it has to in the following order:

(1) If the first data is on the frequency say 1, the second data may be on the frequency 1/4, or 1/16 or 1/64 or 1/256 or 1/1024 . . . .

(2) The third data will be on the corresponding frequency of 1/16 or 1/64 or 1/256 or 1/1024 or 1/4096 . . . e.g. if I choose the second data as 1/16 I have to choose the third data 1/64. Or, say if I have chosen the second data 1/4 I have to choose third data as 1/16.

(3) The fourth data will be on the corresponding frequency of 1/64 or 1/256 or 1/1024 or 1/4096 or 1/16384 . . . e.g. the first data is 1 (by default) I have chosen second data as 1/4, then the third data for the frequency would be 1/16 and the forth data would be 1/64. However, if I chose the second data as 1/256 (the first data for the frequency remains 1 by default in any case). The third data in this case will be 1/1024 and the fourth data on the frequency will be 1/4096.

(4) The fifth data on the frequency will be 1/256 or 1/1024 or 1/4096 or 1/16384 or 1/65536 . . . e.g. The first data is 1 (by default), the second data we have chosen is 1/256, then the third data would be 1/1024, the fourth data will be 1/4096 and the fifth data will be 1/16384. These are data on the frequencies are to be adhered to for the design which I can carry the inverse or reverse process i.e. fifth data may be 1 (unity), the fourth data say I choose 16, then the third data would be 64, second data would be 256 and the first data be 1024 times the frequency.

Since data transmission is already covered for ASCII characters, our limitation for the use of such circuit on V.92 is solely for audio/video/image/voice characteristics for transmission. I have to make a judicious choice for the data on frequency for these characteristics viz., whether video is first data (viz. the compressed analog TV signal is 1.544 Megabits/sec) or whether data is at the first level (which include frame relay) the audio be second data on frequency and image and voice be third and fourth data. The high impedance switch is employed for switching. A very little reference voltage is required. The pulses of reference voltage is passed to respective differential amplifier separately before passing through the Mixer and Modulator. It has to be noted that in passing through the modulator, the analog mixed signals are impressed upon the frequency of career wave. After the signal reaches the receiving point, it is passed through the negative feedback high pass filter amplifier and the signal so received is impressed upon VCO (Voltage controlled oscillator) or VFO (Variable frequency oscillator). The method of separating signals are as with amplifiers with negative feedback. The successive results of the amplifier is XORed with VCO/VFO output and video/audio/image and voice data are available at the receiving end.

Obviously, the advantage of the invention is that audio/video/image/voice data are available on real time basis.

### SUMMARY

In accordance with the present invention the support circuitry for high speed audio/video/image and voice data is designed and to be embedded with V.92 modems and with applications for claim 1 through 11

### DRAWINGS—FIGURES

### DETAILED DESCRIPTION OF FIGURES

There are four or five data simultaneous separate data bus (data bus 11, 12, 13, 14, 15 . . . as defined in the figure) initiating from DTE (Data terminal equipment) in the form “1's” and “0's” e.g. 1001110101011 . . . . However, the frequencies of the data bus are defined as stated above. As these four or five data bus pulses pass the high impedance switches, they go through the differential amplifier (for mapping). The category are allocated judiciously e.g. data bus 11 for data (which include frame relay), data bus 12 for video, data bus 13 for audio etc. Once the data bus pass through the mixer, it goes through the modulator and finally through the career. The modulator gives the low frequency e.g. required by for career frequency transmitting.

On the receiving end, the waveform is passed through high pass filter to VCO or VFO. For separating the different waveform for data, video, audio, voice etc. the amplifier with negative feedbacks are so connected. The output from the amplifier are XORed with the VCO or VFO output and different data streams so obtained are the transmitted data for data, video, audio, voice etc.

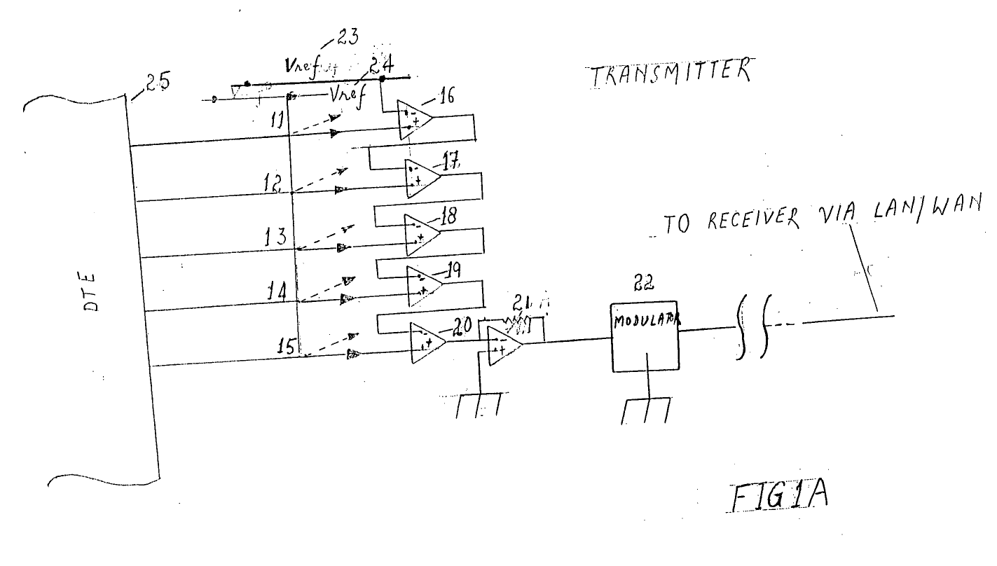

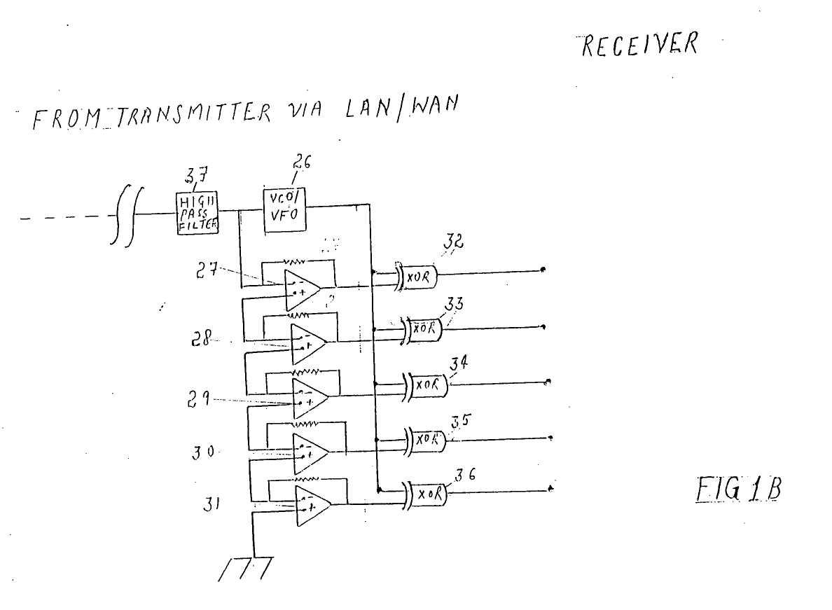

(1) FIG. 1A shows a DTE (Data Terminal Equipment) with the 5 different data bus video/audio/voice/data/images (after final design) are controlling the switches of the five separate but identical differential amplifiers 16, 17,18, 19, 20. The component 21 is amplifier with negative feedback. The form so coming out from this mixer is micro-high frequency with low DB factor which is to be impressed upon modulator (22).

(2) FIG. 1B, on receiving end of the LAN/WAN/Ethernet/telephone modem/DSL/Cablemodem line it has to pass through high pass filter and then impressed upon VCO (Voltage controlled Oscillator) or VFO (Variable Frequency Oscillator) and the amplifier design is used for separating wave form, which is XORed with VCO/VFO output.

The details of the figures are:

FIG. 1A

11, 12,13, 14, 15—High Impedance switching transistors

16, 17, 18, 19, 20—Differential Amplifier

21—Amplifier with negative feedback

22—Modulator for career frequency

23, 24—Vreference going through the switches or directly to differential amplifier as in the figure.

25—Data Terminal Equipment computer/server etc.

FIG. 1B

26—Voltage Controlled Oscillator (VCO)/Variable Frequency Oscillator (VFO)

27, 28, 29, 30, 31—Amplifier with negative feedback

32, 33, 34, 35, 36—High Impedance XOR gates

37—High Pass Filter

### CONCLUSION RAMIFICATION AND SCOPE

The above design has to be employed with V.92 for high speed and simultaneous real time data transmission for both upstream and downstream for audio/video/voice etc. and different applications as in claim 1 through 11

I claim:

1) The method of the data bus 1,2,3,4,5, . . . as described with the numerical values of corresponding frequencies for the serial bus.

2) The method at DTE or DCE level for transferring the bits separately at different frequencies, with frequencies divider or frequencies multiplier so conceived.

3) The method of mapping and mixing the signals.

4) The method of separating the mixed signals.

5) The design of VCO/VFO, Mixer, modulator and amplifier as applicable for the circuit design.

6) The circuit or project as whole integrating with V.92. When transmitting, the modem impose (modulate) a computer's digital signals into continuous carrier frequency on the telephone line (or LAN/WAN/Ethernet/DSL/Cable Modem as the case may be). When receiving, modems sift out (demodulate) the information from the carrier and transfer it in digital form to the computer.
The carrier frequency and the DNS switching latency (discussed in a different claim) are the main point for internet communications. If DNS switching (or the IP routing over the nodes physical or logical addresses) is done similar to telephone switching (with other proposal), the micro-digital signals into continuous carrier frequency on the telephone line can transfer the multimedia data and will be without latency. Such signal may be mixed like a complex signal of data, voice, video, image, audio and be separated at the other end (even if the IP routing over the node is not like telephone switching) e.g. ATM.
The mixing design is done by passing the relative velocity through differential amplifier and through the mixer and at other end, through VCO/VFO over the high pass filter amplifier, the results of which are subsequently XoRed with the separating amplifiers. This way the complex data signals data, image, audio/video are separated and hence are available on real time. For keeping the data transmission accuracy CRC is performed on data.

7) The sequencing and mapping of DNA sequence can be facilitated in much more conversant way by using the relative velocity concept of different letters in DNA sequence. In certain instances limitations are computation limit of the computer.
To design a system or pc integrator in which each letter are indicated by pulses and these letters move separately in their own group e.g. all T's are separated and moving with the velocity, say V. At the same time all the C's are moving with the velocity n*V where n is a floating number chosen randomly say 0.0005. Similarly all G's are moving with n1*V where n1 is again any floating number say 0.00002 and so on. The highest accuracies for such floating point results depend upon the final design.
The main idea of the project is to mix all the signals at varied speeds, to separate the signals and to map them for ready findings of the genes or sequence in question. Since the present computers are not equipped with this we have to design the electronics with the basic components such as differential amplifiers, amplifiers, mixers, VCO/VFO and XoR gates with very high impedance. The VCO/VFO and other components are to designed by the first principles to meet the final design standards.
In addition to the biology laboratory computer the design will be useful in general computer design and data communication.

8) The design of digital DVD for computer or to store the digital data for audio/video/image/sound/data and numeric and to play them in real time may not be with ease as for the interleaving of various data and their separation on the hard disk drive or DVD/CD-ROM. In fact, if we need to write or read and transfer this data over the modem, shall provide us with uniformity to avoid any latency. Such latency can clearly be avoided in LANs using ethernet without routers, PSTN etc. In the networks using PSTN, a design criteria for telephone switching for DNS recommended for better VoIP and other forms of data (to be with separate claims).
This claim is:
How to design read/write heads and the control modules for the hard disks, cd-rom and DVD to write and read the digital information for various kinds of datas in real time?
Since the present computers are not equipped with this, the entire new computational electronics design has to be accomplished. Such a design clearly incorporates the quantum (mechanics) electronics computation. The design incorporates mixing the signals at different velocities through the differential amplifier, and using of mixers, separators, XoR gates and most importantly precise oscillators VFO/VCO. In order to meet the design criteria many of the components are to be designed from the first principles.
Hence the final design of this system integration in the PC, Servers etc. shall felicitate the read (or display/sound etc.)/write (of all kinds of data) concomitantly.
Upon this system ready, by the use of micromodem the system can transmit smoothly, concomitantly various datas, (video/audio/image/sound and numeric). In fact the design of micro-modem is also the same as above.

9) The memory mapping in the computer's architecture has a factor of latency in microprocessor efforts to reach memory and the cache level 1 and 2 came. The memory banks and addresses are interleave together and accordingly the access to these memory banks cause increased latencies.
The claim is:
How we can access the memory mapping in real time better than we could access cache?
The different memory can be accessed by designing criteria based on relativity. Say there are memory banks with addresses 1 to 100, 200 to 300, 300 to 400 . . . . Different relative speeds signals for accessing the memory locations are mixed and separated at the memory banks. Precisely the memory are accessed in real time. But this capability does not exist with the computers.
Hence we have to design using electronic components from the first principles. The mixer and separator numbers to be same as number of memory banks. The VFO/VCO essentially replaces the need for address search. Results are XoRed on the separator just before the memory bank. If the relative velocity at the start of first bank is V, second bank may be say n1*V, and third bank say n2*V and so on . . . ; where n1, n2, n3 . . . may be 1 or any floating points depending on the final design. The different velocities will be felicitated by phase locked loops (not by computer generated random numbers). This way the mapping can be felicitated real time concomitantly.
